(19) United States
(12) Patent Application Publication
(10) Pub. No.: US 2017/0039515 A1
(43) Pub. Date: Feb. 9, 2017

(54) APPARATUS AND METHOD FOR COLLECTING CUSTOMER INVENTORY INFORMATION

(71) Applicant: Wal-Mart Stores, Inc., Bentonville, AR (US)

(72) Inventor: Bruce W. Wilkinson, Rogers, AR (US)

(21) Appl. No.: 15/230,132

(22) Filed: Aug. 5, 2016

Related U.S. Application Data
(60) Provisional application No. 62/202,717, filed on Aug. 7, 2015.

(51) Int. Cl. G06Q 10/08; H04L 29/08

(52) U.S. Cl. CPC G06Q 10/087; H04L 67/306; G06Q 10/0833

(57) ABSTRACT

Systems, apparatuses and methods are provided herein for collecting customer inventory information. In one embodiment, a system for collecting customer inventory information includes a communication device configured to communicate with a shipment system, a customer profile database storing customer profiles comprising estimated inventories of items at a customer location for each customer, and a control circuit coupled to the communication device and the customer profile database. The control circuit being configured to receive, from the shipment system, returned item information from a first shipment delivered to a customer, determine an estimated quantity of an item based at least on the returned item information, and update an estimated inventory of items at a customer location for the customer in the customer profile database based on the estimated quantity of the item.

### RELATED APPLICATIONS

This application claims the benefit of U.S. Provisional application No. 62/202,717, filed Aug. 7, 2015, Docket No. 8842-135314-US (820US01), which is incorporated in its entirety herein by reference.

### TECHNICAL FIELD

This invention relates generally to product delivery services.

### BACKGROUND

Conventionally, customers may order items they need from sellers, pay for the items, and sellers will mail or deliver the items to the customer. With a subscription model, sellers may send items that the customer specifically subscribed to on a periodic basis.

Planned meal delivery services have become popular in recent years. With planned meal delivery, providers send all ingredients (aside from a few staples such as olive oil, salt, and pepper) needed to prepare a planned meal to a customer periodically. The “staples” are assumed to be always available at the customer's premise and never provided by the seller.

### BRIEF DESCRIPTION OF THE DRAWINGS

Disclosed herein are embodiments of apparatuses and methods for collecting custom inventory information. This description includes drawings, wherein:

FIG. 1 is a block diagram of a system in accordance with several embodiments.

FIG. 2 is a flow diagram of a method in accordance with several embodiments.

FIG. 3 is a flow diagram of a general process in accordance with several embodiments.

FIG. 4 is a system diagram of a smart crate in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for collecting customer inventory information. A system for collecting customer inventory information includes a communication device configured to communicate with a shipment system, a customer profile database storing customer profiles comprising estimated inventories of items at a customer location for each customer, and a control circuit coupled to the communication device and the customer profile database. The control circuit being configured to receive, from the shipment system, returned item information from a first shipment delivered to a customer, determine an estimated quantity of an item based at least on the returned item information, and update an estimated inventory of items at a customer location for the customer in the customer profile database based on the estimated quantity of the item.

In a planned meal subscription, all ingredients required may be delivered with the first shipment in order to ensure that the customer has all the ingredients to prepare the planned meal. This may be done without first requiring the customer to take an inventory of existing quantities of things like spices, ketchup, mustard, etc. In a delivery where an ingredient is needed for the first time, the ingredient may be sent with the meal plan without knowing whether the customer already has the ingredient or not. If the customer already has the ingredient, then the customer can use a seller application (“app”) to scan the barcode of the ingredient and acknowledge the quantity he/she already has. This unopened item would be put back into the delivery cooler where it can be picked up and returned to retailer through reverse logistics.

The disclosed system does not require the customer to go through a process of taking a complete inventory of their refrigerator, spice rack, pantry, etc. in order for the system to learn what ingredients the customer has at his/her premise. Some embodiments of the disclosed system assume the customer has none of the necessary ingredients and sends all of them with the first shipment. When the customer scans the unneeded items for return, they also provide an inventory of ingredients they already have. By answering questions about how much of each item they have, a reasonable estimation of the inventory at the customer's premise can be obtained with minimal effort on the part of the customer. The ingredients that are not needed can be returned by placing them in the cooler for pick up by the delivery personnel. The ingredients that are not returned can then be billed to the customer. The customer inventory information can then be collected and aggregated over multiple shipments and returns.

The meal planning engine may generate a pick list of ingredients needed for the preparation of the planned meal. While some of the ingredients are likely to already be at the customer's home, the pick list will initially assume the customer does not have the needed ingredient. Therefore, the pick list will include all of the needed items so that the items are delivered to the customer. When the customer receives the ingredient they can verify if the delivered items include ingredients they already have. The customer may open up a smart device app and scan the unneeded item's barcode and the app may request the customer to enter an estimate of the quantity of what they already have. Customer then enters the estimated quantity. This estimate may be used to estimate an approximate inventory for ingredients in the possession of the customer for selecting items to include in the future shipments.

When the confidence that the inventory of that item is too low where it might put the ability of the customer to prepare the meal in doubt, then the ingredient will be sent. If it turns out that it is still not necessary, the return process may be repeated. If the customer does not scan the barcode of the returning items, the fact that the item was returned may still indicate that the customer has at least some of the returned ingredient. This may also be used to estimate the inventory quantity at the customer premise.

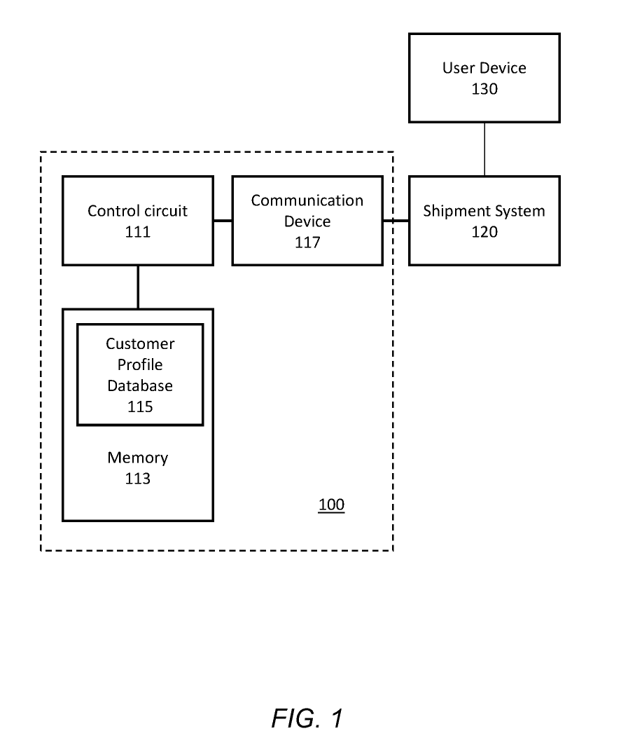

Referring now to FIG. 1, a system for collecting customer inventory information is shown. The system 100 includes a control circuit coupled to a memory 113 including a customer profile database 115 and a communication device 117 for communicating with a shipment system 120.

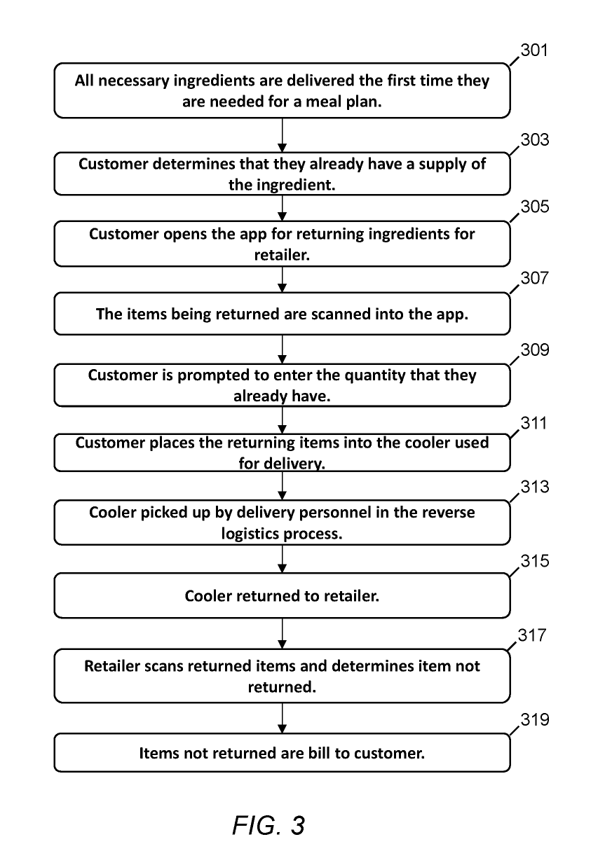

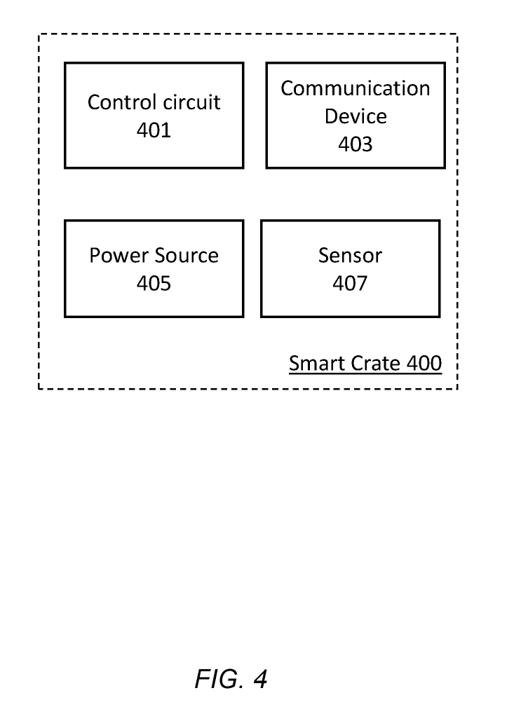

The customer inventory estimation system 100 may be any processor-based device. In some embodiments, the customer inventory estimation system 100 may be generally referred to as a customer inventory server and/or a central computer system. Generally, the customer inventory estimation system 100 is configured to estimate a customer inventory based on shipping information from the shipment system 120 and store the estimated customer inventory in the customer profile database 115. The customer inventory estimation system 100 may further be configured to provide the customer inventory information to the shipment system for use in determining items to be included in the next shipment. In some embodiments, the shipment system 100 further communicates with a user device 130 to receive return item information that is in return provided to the customer inventory estimation system 100. The control circuit 111 may be a central processing unit, a processor, a microprocessor and the like. The control circuit 111 may be configured execute computer readable instructions stored on the memory 113 to carry out one or more steps in the methods described with reference to FIGS. 3-4 herein.

The memory 113 may comprise volatile and/or non-volatile memory. The memory 113 has stored upon it, a set of computer readable instructions which, when executed by the control circuit 111, causes the system to process the information received from the shipment system 120 to generate and update estimated customer inventory information in the customer profile database 115. Generally, the computer readable instructions may cause the control circuit 111 to perform one or more steps in the methods described with reference to FIGS. 3-4 herein. In some embodiments, the instructions stored on the memory 113 may further cause the control circuit 111 to update the estimated customer inventory in the customer profile database 115 based on other information such as the customer's purchase history, the customer's manually entered inventory information, custom's estimated usage rate, and known meals and/or projects prepared by the customer, etc.

The customer profile database 115 may be implemented with the same physical device(s) as the memory 113 as shown in FIG. 1 or may be implemented with different physical device(s). In some embodiments, the customer profile database 115 may be external the system 100. Generally, the customer profile database 115 may be implemented with one or more of local, external, server-based, or cloud based storage. In some embodiments, the customer profile database 115 may be accessed and updated by other systems. The customer profile database 115 may have stored upon it a number of customer profiles each associated with a customer and/or a customer household of a retail entity. The customer profile database 115 includes an estimated inventory of items at a customer location. Customer location may include one or more of customer residence and customer place of business. The estimated inventory of items at a customer location may include a list of individual items and/or categories of items. For example, the estimated inventory of items may include items such salt, pepper, cumin, dried thyme, toilet paper, diapers, detergent, lipstick, etc. and/or may list specific products such as Great Value almonds, Equate intense therapy lotion, etc. Generally, the customer profile may include estimated the inventory level of any item or category of items offered for sale. In some embodiments, the customer profile database may also store estimated customer inventory information for non-consumable items such as pots, pans, cooking gadgets, small household appliance, etc.

The customer profile database may store other customer information such as customer dietary preferences (vegetarian, vegan, low sodium, etc.), taste preferences (hearty, light, sweet, etc.), cuisine type preferences (southern, Asian, Mexican, etc.), brand preferences, demographic, shopping history, etc. that may be used along with the estimated customer inventory to determine what items to deliver to the customer.

The communication device 117 may comprise a wired and/or wireless communication device such as one or more of a network adapter, an internet modem, a local network adapter, a data I/O port, a wi-fi adapter, and the like. Generally, the communication device 117 is configured to communication with a shipment system 120 that may be directly connected to the customer inventory estimation system 100 or accessible through one or more of the internet, a local area network, a secure private network, and the like.

The shipment system 120 comprises a system that receives and processes information regarding returned items. For example, an item may be left in a delivery box for a delivery person to retrieve. The returned item may be logged at the shipment system 120 either at retrieval by the delivery personnel and/or when the item returns to a distribution center. The user may also use a personal device 130 such as a computer, a smartphone, a tablet computer etc. to scan an item for return, and provide the return item information to the shipment system 120 and/or the customer inventory estimation system 100. In some embodiments, the shipment system 120 also determines what items to ship to a customer based at least on information in the customer profile database 115. The shipment system 120 may select a list of items to deliver to the customer. The shipment system 120 may check the estimated inventory level at the customer's location for each item on the shipping list and exclude any items that have a high inventory level. For example, the shipment system 120 may select a recipe requiring coconut milk, curry powder, bell peppers, and ginger to provide to a customer. The customer profile database 115 may indicate that the customer is estimated to have an insufficient quantity of coconut milk for the recipe, a sufficient quantity of curry powder, and unknown levels of inventory for bell peppers and ginger. There may be no estimated quantity of an item if that item has not been delivered to the customer before or too much time has passed since the last delivery for the estimated amount to be useful. In this example, the shipment system may determine to deliver only coconut milk, bell pepper, and ginger to the customer, and omit curry powder for that shipment. In some embodiments, the shipment system may also determine the quantity of the item to send based on the estimated inventory quantity stored in the customer profile database. For example, the shipment system may select a recipe for a customer that requires ten eggs. If the customer profile indicates that the user is estimated to have a half-dozen eggs, the system may only send another half-dozen eggs along with the recipe. If the user is estimated to have no eggs, the system may send one dozen eggs instead. Meal recipes are used here as examples only, the shipment system 120 may use similar methods to generate a shipping list including any items such as craft project items, cleaning supplies, toiletries, cosmetics, baby products, etc. In some embodiments, when the next shipment is associated with a recipe, the system may determine whether an item is high or low in quantity based on whether there is sufficient quantity to prepare the meal in the recipe. In some embodiments, when an item is known to be consumed constantly (e.g. toilet paper, soap), the system may determine whether an item is high or low in quantity based on whether the item is likely to run low/out before the next shipment. Generally, the shipment system 120 is configured to use the customer profile database 115 to provide the customer with what they need and maximize the possibility that the customer will keep each item in a shipment. Generally, the shipment system 120 may include one or more devices that are used to process information relating to items delivered to and/or returned from customers. The shipment system 120 may be a system that includes one or more control circuits, memories, and communication devices.

The user device 130 may be any device with at least a processor, a communication device, and a user interface device. For example, the user device 130 may be a smartphone, a personal computer, a tablet computer, a laptop computer, a head mounted display device, a wearable device, etc. In some embodiments, the user device 130 may further include a sensor for scanning product information from products the customer intends to return. For example, the user device may include an optical sensor, a RFID scanner, a barcode scanner, etc. In some embodiments, the user device 130 may provide an item return user interface to the customer. The item return user interface may allow the customer to enter/scan/select items they wish to return. The user interface may also prompt the user to estimate the quantity of an item at the customer's location that is associated with the item being returned. In some embodiments, the user interface may also ask the user for the reason for returning the item. For example, the customer may be prompted to indicate whether they are returning the item because they already have the item, they do not like the item, or they prefer a different type or brand of the item. The reason for return may also be used to estimate the customer inventory. The user interface may be provided by the user device 130 via an application installed on the user device 130 and/or accessing a seller website.

In some embodiments, the customer inventory estimation system 100 and/or the shipment system 120 may further communicate with a smart crate. A smart crate generally refers to a container having at least a microprocessor and a sensor. The sensor of the smart crate may collect information relating to items delivered, retrieved, and/or left in the container for return. The inventory estimation system 100 may communicate with the user device 130, the shipment system 120, and/or the smart crate via the same or different communication devices. In some embodiments, the return item information from two or more of the user device 103, the shipment system 120, and the smart crate may be compared to verify the collected information.

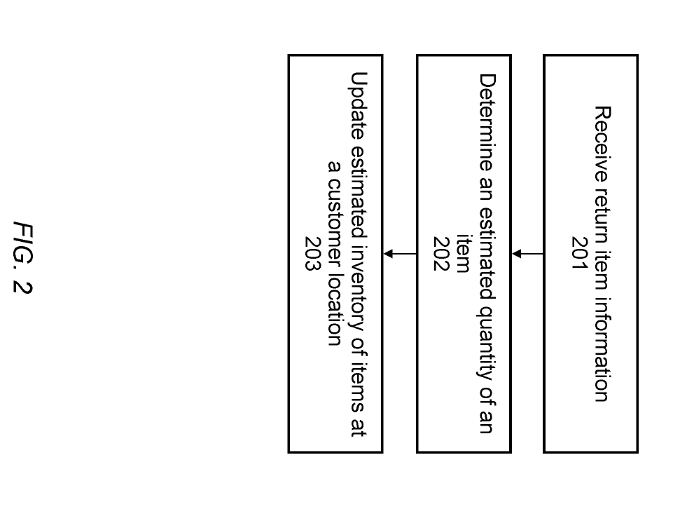

Referring now to FIG. 2, a method of collecting customer inventory information is shown. Generally, the method shown in FIG. 2 may work with a periodic delivery service with which a seller delivers a set of items to a customer without the customer specifically picking out each item for purchase. For example, a seller may place a crate at the customer's location and periodically drop off items that the customer may need in the crate. The customer may remove any item he/she wishes to purchase from the crate and leave all other items in the crate for the next delivery person to retrieve and return to the seller. The customer would then only be billed for items that are kept. In some embodiments, the periodic delivery service may be based on a list of associated items, such as a meal recipe, items for a craft project, items for a children's activity, etc. For example, the system may select a recipe for the customer based on user-entered preference and/or user purchase history and send ingredients needed to prepare a meal according to the recipe. If the customer already has one or more ingredients on the recipe and does not wish to purchase more of those ingredients, the customer may leave that ingredient in the delivery container to return to the seller.

In step 201, the system receives return item information from an earlier delivery. The return item information may include one or more of the type of item returned, the quantity of item returned, customer estimated inventory quantity at the customer's location, and the customer's reason for returning the item. A customer may return an item by leaving the item in a delivery box or crate. In some embodiments, the delivery box may have sensors to detect that the crate has been opened and/or which items have left the box and transmit that information to a shipment system. A more detailed description of a smart crate that may be used with some embodiments of the method described herein is described in more detail with reference to FIG. 4 below. In some embodiments, the returned item may be scanned by the delivery person when the item is retrieved and/or when the item is delivered or shipped back to the seller facility. In some embodiments, the customer may scan the items he/she wishes to return. A user interface may be provided to the customer for the customer to indicate which items are being returned. In some embodiments, a shipping list associated with the delivery may be displayed to the user, and the user can select items not being kept from the packing list. In some embodiments, the user device may scan the barcode, the packaging, and/or the RFID tag on the product to indicate which items are being returned. In some embodiments, the user interface may further prompt the user to enter an amount of the item that the user has in his/her possession. For example, if a user is returning a bottle of black pepper, the user may be prompted to enter an estimated quantity of black pepper he/she has. The customer estimated amount may be based on item count or unit measurements such as grams, ounces, and liters. In some embodiments, the user interface may display a container associated with the item and the user may indicate the estimated quantity by adjusting the fullness of the container. In some embodiments, the customer may indicate a reason for returning the items. For example, the customer may indicate that they already have the item in stock, that they do not like the recipe and do not intend to prepare it, that they prefer a different type or brand of the ingredients, and/or that they are using a substitute ingredient with the recipe, etc.

In step 202, the system determines an estimated quantity of an item based at least on the return item information received in step 201. In some embodiments, the customer is prompted to estimate a quantity of the item at their location when returning the item, and step 202 is based on the customer estimation. The customer may be prompted to enter the estimated amount before or after the customer prepares the recipe/project associated with the shipment. In some embodiments, the system may estimate the quantity of an item at the customer location based on a default amount. For example, if a customer returns a gallon of milk, the system may assume the customer has at least half of a gallon of milk at his/her location. In some embodiments, the system may estimate the quantity of an item at the customer location by adjusting a previously estimated quantity. For example, if the customer returns an item that was previously estimated to be low in quantity, the system may adjust the estimated quantity upwards.

In step 202 the system may use other information to estimate the quantity of an item at the customer location. In some embodiments, if an item is kept by the customer, the estimated quantity may be set to that of the kept item. In another example, if the customer is sent ingredients for a recipe, the system may decrement the estimated quantity of each item based on the quantity of each item used in the recipe. For example, if the customer is sent 10 oz. of cumin and a recipe delivered with the cumin calls for 2 oz. of cumin, the estimated quantity of cumin at the customer's location may be set to 8 oz. prior to the next shipment. In another example, if the system estimates that the customer still has 8 oz. of cumin and does not send cumin with a recipe that calls 2 oz. of cumin, the system may adjust the estimated quantity of cumin at the customer's location down to 6 oz. prior for the next delivery. In some embodiments, the estimated inventory of items may be further based on recent purchase history of the customer. For example, if a customer purchases a new bottle of olive oil outside of the automatic delivery system, the system may set the estimated quantity of olive oil at the customer location to the quantity of the purchased olive oil. In some embodiments, the system also allows the customer to manually change and adjust the estimated customer inventory information stored in the customer profile database.

In some embodiments, the estimated quantity of at least some items may be periodically reduced at an estimated rate of use. For example, the system may estimate that a family uses a roll of toilet paper per week, and reduces the estimated quantity of toilet paper rolls at the customer's location by one roll per week. In step 202, the return information may be used to adjust the estimated rate of use. For example, if the system estimates that there should be two rolls of toilet paper at the customer's locations but a delivery of toilet paper is not accepted by the customer and the customer indicates that they still have six rolls of toilet paper, the system may adjust the estimated rate of use down to 0.8 rolls a week. In some embodiments, the system may further adjust the estimated quantity of an item at the customer's location based on the item's expiration date. For example, if a gallon of milk with an expiration date of July 13 was previously delivered, the system may set the estimated quantity of milk to “none” on July 13.

In step 203, the system updates the estimated inventory of items at a customer location stored in a customer profile database based on the estimated quantity in step 202. In The estimated inventory of items at a customer location may list individual items and/or categories of items. Generally, the customer profile may estimate the inventory level of any consumable item offered for sale. In some embodiments, the customer profile database may also be used to estimate customer inventory information for non-consumable items such as pots, pans, cooking gadgets, small household appliances, etc. The customer profile database may store other customer information such as customer dietary preferences, brand preferences, demographic, shopping history, etc. that may be used along with the estimated customer inventory to determine what items to deliver to the customer in subsequent shipments. In some embodiments, the return item information may also be used to update customer's preference information in the customer profile. For example, a customer may indicate that they returned cumin because they do not like the taste of cumin. The customer profile may then be updated to avoid sending recipes containing cumin to the customer. In another example, the customer may return a cartoon of eggs and indicate that they only eat organic eggs. The customer profile may then be updated to reflect the customer's preference.

In some embodiments, after step 203, the information stored in the customer profile database is used to select items to include in a subsequent delivery to the user. For example, if the second shipment is associated with a list items, such as a recipe, any item in the list of items having a high estimated quantity in the estimated inventory at the customer location may be excluded from the second shipment. In some embodiments, when there is no estimated inventory of a particular item at the customer location, the system may determine to ship that item to the customer. For example, a shipment system may select a recipe requiring coconut milk, curry powder, bell peppers, and ginger to provide to a customer. The customer profile database may indicate that the customer is estimated to have an insufficient quantity of coconut milk for the recipe, a sufficient quantity of curry powder, and unknown levels of inventory for bell peppers and ginger. There may be no estimated quantity of an item if that item has not been delivered to the customer before or too much time has passed since the last delivery for the estimated amount to be useful. In this example, the shipment system may determine to deliver only coconut milk, bell pepper, and ginger to the customer, and omit curry powder for that shipment. In some embodiments, the shipment system may also determine the quantity of the item to send based on the estimated inventory quantity stored in the customer profile database. For example, the shipment system may select a recipe for a customer that requires ten eggs. If the customer profile indicates that the user is estimated to have a half-dozen eggs, the system may only send another half-dozen eggs along with the recipe. If the user is estimated to have no eggs, the system may send one dozen eggs instead. Meal recipes are used here as examples only, the shipment system may use similar methods to generate a shipping list including any items such as craft project items, cleaning supplies, toiletries, cosmetics, baby products, etc. In some embodiments, when the next shipment is associated with a recipe, the system may determine whether an item is high or low in quantity based on whether there is sufficient quantity to prepare the meal in the recipe. In some embodiments, when an item is known to be consumed constantly (e.g. toilet paper, soap), the system may determine whether an item is high or low in quantity based on whether the item is likely to run low/out before the next shipment. Generally, the shipment system is configured to use the customer profile database to provide the customer with what they need to maximize the possibility that the customer will keep each item in a shipment.

The steps in FIG. 2 may be repeated after each shipment has returned items. Over time, the estimated inventory of items in the customer profile may be constantly updated and adjusted based on a multiple of shipments and returns to reflect the actual inventory of items at the customer location.

Now referring to FIG. 3, a process for item delivery and return is shown. FIG. 3 is an example of a meal plan delivery service. In some embodiments, prior to step 301, the system may select one or more customized recipes for the customer based on one or more of customer demographic, past shopping habits, user entered preferences, etc.

In step 301, all necessary ingredients are delivered the first time they are needed for a meal plan. For example, the meal plan may include one or more recipes, and all ingredients in the recipe may be delivered. In some embodiments, cooking utensils, appliances, preparation tools, serving utensils, containers, flatware, etc. that may be used to prepare the meal may also be delivered. In some embodiments, the ingredients are delivered to a crate that is kept at the customer's location. In some embodiments, the ingredients are delivered with a portable container such as a cooler.

In step 303, the customer determines that they already have a supply of at least some of the ingredients. After the ingredients are delivered, the customer may review the content of the delivery and determine if they wish to purchase each of the items delivered. If they have sufficient quantity of an item already, they may decide to return that item back to the seller.

In step 305, the customer opens an app for returning ingredients to the retailer. In some embodiments, an item return user interface may be provided through a seller mobile app and/or a seller website. In step 307, the items being returned are scanned into the app. In some embodiments, a barcode, a label, and/or a packaging of an item may be scanned by an optical sensor of a user device such as a smartphone, a personal computer, a tablet device, a wearable device, a head mounted display device, etc. In some embodiments, the seller app or website provides a user interface for the user to enter one or more of a product name, product description, product quantity, etc. In some embodiments, the seller app or website may provide a list of items included in the most recent delivery and the user can select from the list of delivered items to indicate which ones they wish to return.

In step 309, the customer is prompted to enter the quantity of the item that they have at the customer location. In some embodiments, the user interface may be provided based on the type of item being returned. For example, for countable items such as apples, eggs, lemons, canned food etc. the user interface may ask “how many” of the items the customer has at their location. For some items, the user interface may ask for an estimated unit measure of the item such a liter, ounce, pound, etc. In some embodiments, the user interface may provide an image of a container associated with the item to help the customer estimate the quantity of the item they have at their location. For example, the user interface may display a spice bottle, an oil bottle, a flour bag, etc. and ask the customer to indicate the current fullness of their container. The customer may select a fullness level using the image of the container displayed on the user interface.

In step 311, the customer places the returning items into the cooler used for delivery. In step 313, the coolers are picked up by delivery personnel in a reverse logistics process. In step 315, the coolers are returned to the retailer facility. In some embodiments, a delivery crate may remain on the customer's premises and only items being returned are picked up and returned to the retailer's premises.

In step 317, the retailer scans returned items and determines which items were not returned by the customer. In some embodiments, the retailer scan may be compared with the customer entered return information in step 307. The customer may be notified if there is a discrepancy. In step 319, the items not returned are billed to the customer. In some embodiments, the system selects items to include in the next delivery after step 319 and return back to step 301 for the next delivery.

In the process shown in FIG. 3, the estimated quantity of items at a customer location may be used in step 301 to determine which items to send. Any item with a high estimated quantity may be omitted in the shipment. The return information from steps 307, 309, and/or 317 may be used to update the estimated quantity of items at a customer location stored in the customer profile database as described with reference to FIGS. 1 and 2 above.

Now referring to FIG. 4, a smart crate 400 that may be used in some embodiments is shown. The smart crate 400 is generally a container with sensing capability. The smart crate 400 includes a control circuit 401, a communication device 403, a power source 405, and a sensor 407. The control circuit 401 may be configured to determine what items are in a container portion of the smart crate 400 based on information from the sensor 407. Information gathered by the sensor 407 may then be used to detect which items are delivered and/or which items are removed by the customer. In some embodiments, the control circuit 401 may be further configured to sense other usage related information such when a lid of the smart crate 400 is opened by either the customer or the delivery person. The communication device 403 may be configured to allow the control circuit 401 to communicate with one or more of a customer home network and/or a seller server. In some embodiments, the delivered and returned item information may be communicated from the control circuit 401 to a seller server via the communication device 403. The power source 405 supplies power to one or more of the control circuit 401, the communication device 403, and the sensor 407. The power source may be one or more of a battery, a wall outlet, and a solar power panel. The sensor 407 may be used to determine items placed and removed from the container. For example, the sensor may be one or more of a bar code scanner, an optical sensor, a radio frequency identification (RFID) tag scanner and the like. In some embodiments, the methods described with reference to FIGS. 2 and 3 may be implemented in part with delivered and returned item information at least partially gathered by the smart crate 400.

In one embodiment, a system for collecting customer inventory information is provided. The system includes a communication device configured to communicate with a shipment system, a customer profile database storing customer profiles comprising estimated inventories of items at a customer location for each customer, and a control circuit coupled to the communication device and the customer profile database. The control circuit is configured to receive from the shipment system returned item information from a first shipment delivered to a customer, determine an estimated quantity of an item based at least on the returned item information, and update an estimated inventory of items at a customer location for the customer in the customer profile database based on the estimated quantity of the item.

In one embodiment, a method for collecting customer inventory information is provided. The method includes establishing a customer profile on a customer profile database, comprising an estimated inventory of items at a customer location for a customer, receiving returned item information from a first shipment delivered to the customer, determining, by a control circuit, an estimated quantity of an item based at least on the returned item information, and updating the estimated inventory of items at a customer location for the customer in the customer profile database based on the estimated quantity of the item.

In one embodiment, an apparatus for collecting customer inventory information is provided. The apparatus includes a non-transitory storage medium storing a set of computer readable instructions, a control circuit configured to execute the set of computer readable instructions which causes to the control circuit to: establish a customer profile on a customer profile database, comprising an estimated inventory at a customer location for a customer, receive from a shipment system, returned item information from a first shipment delivered to a customer, determine an estimated quantity of an item based at least on the returned item information, and update the estimated inventory at the customer location stored on the customer profile database based on the estimated quantity of the item.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for collecting customer inventory information, comprising:
a communication device configured to communicate with a shipment system;
a customer profile database storing customer profiles comprising estimated inventories of items at a customer location for each customer; and
a control circuit coupled to the communication device and the customer profile database and configured to:
receive, from the shipment system, returned item information from a first shipment delivered to a customer;
determine an estimated quantity of an item based at least on the returned item information; and
update an estimated inventory of items at the customer location for the customer in the customer profile database based on the estimated quantity of the item.

2. The system of claim 1, wherein the control circuit is further configured to:
provide a user interface for the customer to enter an inventory quantity at the customer location associated with the item;
wherein the determining of the estimated quantity of the item is based at least on an customer estimated inventory quantity of the item.

3. The system of claim 1, wherein the control circuit is further configured to:
determine a content of a second shipment based on the estimated inventory of items at the customer location.

4. The system of claim 3, wherein the second shipment is associated with a list of items and any item in the list of items having a high estimated quantity in the estimated inventory of items at the customer location is excluded from the second shipment.

5. The system of claim 1, wherein the first shipment comprises every item from a list of items selected for the customer.

6. The system of claim 5 wherein the list of items comprises a recipe and the items comprise ingredients of the recipe.

7. The system of claim 1, wherein the control circuit is further configured to:
decrement estimated quantities of each item in the estimated inventory of items at the customer location according to a list of items associated with the first shipment.

8. The system of claim 1, wherein the control circuit is further configured to: update quantity information of items included in the first shipment and not returned by the customer based on a quantity of each item in the first shipment.

9. The system of claim 1, wherein the estimated inventory of items at the customer location is determined based on a plurality of shipments.

10. The system of claim 1, wherein the control circuit is further configured to: select a list of items for a second shipment based on information stored in the customer profile database.

11. The system of claim 1, wherein the control circuit is further configured to:
determine customer preference information based on the returned item information.

12. A method for collecting customer inventory information, comprising:
establishing a customer profile, on a customer profile database, comprising an estimated inventory of items at a customer location for a customer;
receiving returned item information from a first shipment delivered to the customer;
determining, by a control circuit, an estimated quantity of an item based at least on the returned item information; and
updating the estimated inventory of items at the customer location for the customer in the customer profile database based on the estimated quantity of the item.

13. The method of claim 12, further comprising:
providing a user interface for the customer to enter an inventory quantity at the customer location associated with the item;
wherein the determining of the estimated quantity of the item is based at least on an customer estimated inventory quantity of the item.

14. The method of claim 12, further comprising: determining a content of a second shipment based on the estimated inventory of items at the customer location.

15. The method of claim 14, wherein the second shipment is associated with a list of items and any item in the list of items having a high estimated quantity in the estimated inventory of items at the customer location is excluded from the second shipment.

16. The method of claim 12, wherein the first shipment comprises every item from a list of items selected for the customer.

17. The method of claim 16 wherein the list of items comprises a recipe and the items comprise ingredients of the recipe.

18. The method of claim 12, further comprising: decrementing estimated quantities of each item in the estimated inventory of items at the customer location according to a list of items associated with the first shipment.

19. The method of claim 12, further comprising: updating quantity information of items included in the first shipment and not returned by the customer based on a quantity of each item in the first shipment.

20. The method of claim 12, wherein the estimated inventory of items at the customer location is determined based on a plurality of shipments.

21. The method of claim 12, further comprising: selecting a list of items for a second shipment based on the customer profile.

22. An apparatus for collecting customer inventory information comprising:
a non-transitory storage medium storing a set of computer readable instructions;
a control circuit configured to execute the set of computer readable instructions which causes to the control circuit to:
establish a customer profile, on a customer profile database, comprising an estimated inventory at a customer location for a customer;
receive, from a shipment system, returned item information from a first shipment delivered to a customer;
determine an estimated quantity of an item based at least on the returned item information; and
update the estimated inventory at the customer location stored on the customer profile database based on the estimated quantity of the item.
